(19) United States
(12) Patent Application Publication
(10) Pub. No.: US 2025/0288496 A1
(43) Pub. Date: Sep. 18, 2025

(54) INDICATOR MODULE FOR A MEDICINE DISPENSING SYSTEM, A MEDICINE DISPENSING SYSTEM AND A METHOD FOR FACILITATING DISPENSATION OF MEDICINE

(71) Applicant: Logistics and Supply Chain MultiTech R&D Centre Limited, Pok Fu Lam (HK)

(72) Inventors: Chi Hung Tong, Pok Fu Lam (HK); Ka Lun Fan, Pok Fu Lam (HK); Chung Hang Leung, Pok Fu Lam (HK); Lok Poon, Pok Fu Lam (HK); Chi Hung Chung, Pok Fu Lam (HK); King Loong Tse, Pok Fu Lam (HK); Yuk Yu Lau, Pok Fu Lam (HK)

(21) Appl. No.: 18/606,194

(22) Filed: Mar. 15, 2024

(51) Int. Cl. A61J 7/04; A47B 67/02

(52) U.S. Cl. CPC A61J 7/0454; A47B 67/02; A61J 2205/20

(57) ABSTRACT

An indicator module for a medicine dispensing system, the indicator module adapted for use with a medicine cabinet including a body, a plurality of indicators disposed on or within the body, each indicator including a unique colour and each indicator corresponding to an individual dispenser, the indicators being activated to provide visual indication to a dispenser of the physical location of an item defined in a medication prescription, wherein the indicators being activated to allow a plurality of dispensers to simultaneously locate items within the cabinet.

### TECHNICAL FIELD

The present invention relates to an indicator module for a medicine dispensing system and medicine dispensing system, particularly, but not exclusively, to an indicator module for a Traditional Chinese Medicine (TCM) dispensing system and a Traditional Chinese Medicine dispensing system. The present invention also relates to a method for facilitating dispensation of medicine, in particular but not exclusively, to a method for facilitating dispensation of Traditional Chinese Medicine.

### BACKGROUND

A medication (or medicine) is prescribed by a healthcare provider (e.g., a doctor) and the medication is defined in a prescription e.g., a physical or digital document. The prescription is generally provided to a pharmacist or other appropriate healthcare professional, who prepares and dispenses the medication defied in the prescription. The prescription defines the name of the medication, the dosage and frequency of administration, and any other special conditions or precautions.

The patient is typically given instructions on how to take the medication, including the dosage and frequency as defined in the prescription. The patient is also made aware of any special instructions or restrictions. It is important for patients to follow these instructions to avoid any potential side effects or adverse effects on the patient.

Traditional Chinese Medicine (TCM) is a health and wellness system developed in China. The system was developed in ancient China and is still practiced today in China and other parts of the world. TCM practitioners use various psychological and/or physical approaches to address health problems. One of the basic tenets is that the body's qi is circulating through channels called meridians having branches connected to bodily organs and functions. TCM generally includes a variety of therapies such as acupuncture, cupping therapy, gua sha, massage (e.g., tui na), qigong or tai chi, dietary therapy, and herbal medicine.

Herbal medicine is an important aspect of TCM. TCM herbal medicine practice includes use of plant elements as well as non-botanic substances such as animal fungi, mineral products etc. There are several thousand compounds used and over 100,000 TCM recipes or formulations recorded. TCM practitioners (i.e., TCM clinicians) dispense various herbal formulations. These formulations comprise one or more TCM compounds (i.e., herbs) that are processed in appropriate ways.

The TCM formulation is prescribed by a qualified practitioner with the appropriate knowledge, skills, and experience. There is however a shortage of experienced TCM practitioners who can act as dispensing staff. It can be quite challenging for inexperienced staff to prepare and dispense TCM formulations based on a prescription, as several herbs i.e., constituent ingredients for TCM formulations look quite similar. Due to the lack of experienced staff training younger staff can be quite time consuming and reduce the speed and effectiveness of TCM medicine dispensation. Inexperienced staff can also make mistakes when preparing TCM formulations based on a prescription due to the ingredients looking similar.

### SUMMARY OF THE INVENTION

In accordance with a first aspect of the present invention, there is provided an indicator module for a medicine dispensing system, the indicator module being adapted for use with a medicine cabinet comprising:
a body,
a plurality of indicators disposed on or within the body,
each indicator comprising a unique colour and each indicator corresponding to an individual dispenser,
the indicators being activated to provide visual indication to a dispenser of the physical location of an item defined in a medication prescription, wherein the indicators being activated to allow a plurality of dispensers to simultaneously locate items within the cabinet.

In one example in use, the indicators being independently activated to allow multiple dispensers to simultaneously locate items within one or more compartments of the cabinet.

In one example the indicator module comprises at least three indicators,
wherein one indicator comprises a first colour, one indicator comprises a second colour and one indicator comprises a third colour, and;
each colour corresponding to a separate dispenser to allow at least three dispensers to simultaneously locate items within the cabinet based on the specific coloured indicator being activated.

In one example the first colour is red, the second colour is blue, and the third colour is green.

In one example the body of the indicator module comprises:
a central portion
at least one lateral extension extending outwardly from the central portion, wherein the lateral extension comprising a bevelled region, and;
the plurality of indicators being positioned on the bevelled region.

In one example, the indicator module comprising at least two groups of indicators,
each group of indicators comprising a plurality of indicators, the indicators in each group being identical to each other,
wherein the body comprises two lateral extensions extending outwardly from the central portion, the lateral extensions extending in opposing directions from the central portion,
each lateral portion comprising a bevelled region, a first group of indicators disposed on a bevelled region of a first lateral extension and a second group of indicators disposed on a bevelled region of the second lateral extension, and;
the plurality of indicators being independently activated, in use, to allow multiple dispensers to simultaneously locate items within the cabinet.

In one example the first group of indicators comprising three indicators and the second group of indicators comprising three indicators,
wherein the indicators in the first group and second group define pairs such that the same indicator in the first and second groups are activated together,
the three indicators in each group being a different colour,
the pairs of indicators being simultaneously activated in use, and;
wherein the indicators in the first group and the second group being activated, in use, to allow three dispensers to simultaneously locate items within the cabinet.

In one example, the indicator module comprising:
an indicator module controller associated with the indicator module,
the indicator module controller operatively coupled to each of the indicators, and;
wherein the indicator module controller is configured to wirelessly receive a message to activate one or more indicators to indicate to one or more dispensers a location of an item defined in a prescription within the compartment associated with the indicator module.

In one example the indicator module controller is configured to activate a plurality of indicators of different colours to indicate to the dispensers associated with the indicators the location of an item defined in a prescription such that the dispensers can simultaneously be guided to the location of the item defined in the prescription.

In one example the indicator module comprising:
a dynamically adjustable label disposed on the central portion of the body, wherein the label displaying a label of the contents of a compartment of the cabinet,
wherein the indicator module controller is operatively coupled to the dynamically adjustable label, and;
the indicator module controller is configured to control a visual appearance of the label or change the contents of the label based on a received wireless message.

In one example the indicator module controller is configured to:
operatively connect to one or more micro switches of a compartment associated with the indicator module, wherein the compartment is a compartment of the medicine cabinet,
determine the position of the compartment based on the position of the micro switch, and;
adjust visual appearance of the label if the compartment is determined to be opened for longer than a threshold time based on the determined position of the compartment.

In one example the dynamically adjustable label is an e-ink module that can display a name or image indicative of the contents of the compartment associated with the indicator module.

In one example the indicator module comprising:
a battery, the battery being operatively coupled to the indicators to power the indicators,
a disable button disposed on the body, wherein the disable button is configured to disable the indicator module or cause the indicator module to enter a sleep mode when the button is actuated,
a reboot button disposed on the body, wherein the reboot button is configured to cause the indicator module to reboot when the reboot button is activated, and;
a USB port on an underside of the body.

In accordance with a second aspect of the present invention, there is provided a medicine dispensing system comprising:
a medicine cabinet, the medicine cabinet comprising a plurality of compartments, wherein each compartment is arranged to retain a medication prescription item,
a plurality of indicator modules, each compartment comprising a single indicator module disposed thereon and associated with the compartment,
wherein each indicator module is according to any one or more statements above or in accordance with the first aspect,
a dispenser control module arranged to receive a medication prescription including at least one prescription item,
a cabinet control module arranged to locate a position of each of the at least one prescription item stored in one of a plurality of predetermined compartment of the medicine cabinet, and;
wherein the indicators of the indicator modules are activated based on the prescription to indicate the physical location of each item defined in the prescription, and;
wherein the indicators are activated to allow a plurality of dispensers to simultaneously locate items defined within the prescription.

In accordance with a third aspect of the present invention, there is provided a medicine dispensing system comprising:
a medicine cabinet,
the medicine cabinet comprising a plurality of compartments,
wherein each compartment is arranged to retain a medication prescription item, each compartment defining a physical location of a prescription item,
a plurality of indicator modules, each indicator module is associated with a single compartment,
each indicator module comprising:
   a body,
   a plurality of indicators disposed on or within the body,
   each indicator comprising a unique colour and each indicator corresponding to an individual dispenser,
   the indicators being activated to provide visual indication to a dispenser of the physical location of an item defined in a medication prescription,
a dispenser control module configured to receive a medication prescription including at least one prescription item,
a cabinet control module configured to locate a physical location of each of the at least one prescription item stored in one of a plurality of predetermined compartment of the medicine cabinet,
wherein the indicators of an indicator module are activated based on the prescription to indicate the physical location of each item defined in the prescription, and;
wherein the indicators are activated to allow a plurality of dispensers to simultaneously locate items defined within the prescription.

In one example the cabinet control module is configured to identify a specific compartment that retains the at least one prescription item, and; the cabinet control module is configured to transmit a signal to an indicator module to activate one or more indicators on the indicator module to visually indicate to a dispenser the physical location of the prescription item.

In one example the dispenser control module is configured to receive multiple prescriptions, each prescription associated with a specific dispenser,
wherein the cabinet control module is configured to:
   locate a physical location of each item in each of the multiple prescriptions, wherein each physical location corresponds to a specific compartment within the medicine cabinet,
   transmit activation signals to each indicator module associated with each compartment that retains an item defined in the prescription, and;
the indicator module on each compartment that retains a prescription item is configured to activate specific indicators associated with each specific dispenser to provide a visual indication to each specific dispenser the physical location of each item in the prescription associated with the specific dispenser.

In one example, the medicine dispensing system comprising a confusion matrix module arranged schedule an activation sequence to activate the indicators in a staggered manner for two or more prescription items that are similar in appearance, defined in a single prescription.

In one example the indicator module comprises at least three indicators,
wherein one indicator comprises a first colour, one indicator comprises a second colour and one indicator comprises a third colour,
each colour corresponding to a separate dispenser to allow at least three dispensers to simultaneously locate items within the cabinet based on the specific coloured indicator being activated, and;
the cabinet control module is configured to independently activate indicators of appropriate colours based on the prescription associated with a specific dispenser, wherein the specific colours of the indicator indicating to the specific dispenser the physical location of an item within the prescription associated with that dispenser.

In one example, the first colour is red, the second colour is blue, and the third colour is green.

In one example the activation sequence is further configured to control the activation of the indicators in a staggered manner for two or more similar prescription items that are present in two or more prescriptions to avoid two dispensers accessing similar prescription items defined in their respective prescriptions.

In one example, the medicine dispensing system comprises a display module arranged to notify a dispenser an error or a potential error associated with at least prescription item of the medication prescription.

The error may include a wrong prescription item being selected due to confusion. The error may relate to an incorrect dispenser accessing a prescription item due an error in the indicator light colour. Other errors are contemplated. The cabinet control module or dispenser control module may be configured to detect one or more errors and present the error on the display module.

In one example the system allows multiple dispensers (i.e., multiple) users to simultaneously fill prescriptions by picking one or more prescription items defined in the prescription.

In one example, the system is adapted to allow three users to simultaneously fill a single prescription by activating the specific indicator colour corresponding to a specific dispenser to guide the dispenser to a location of a prescription item. The dispenser control module may be configured to associate one or more items from the prescription to a dispenser such that no dispenser has to access the same item. The cabinet control module may be configured to receive the list of items and the item association to the dispenser i.e., the relationship between each item and associated dispenser. The cabinet control module is further configured to activate the indicator of the colours associated with the dispensers to guide the dispensers to the physical locations of the items associated with each dispenser, such that the dispensers can simultaneously gather their respective items to fill the prescription.

In a further example, the system is adapted to allow multiple dispensers to simultaneously fill multiple prescriptions, wherein each dispenser is associated with a single prescription. The dispenser control module may be configured to transmit a plurality of prescriptions to the cabinet control module, wherein each prescription is associated with an individual dispenser i.e., each dispenser is responsible for a single prescription. The cabinet control module may be configured to identify the physical locations of each item in each prescription. The cabinet control module may be further configured to activate the indicators of the colours associated with each dispenser to guide each dispenser to the physical locations of the items within their respective prescription, wherein the specific coloured indicators being activated allows multiple dispensers to simultaneously fill multiple prescriptions.

In accordance with a further aspect of the present invention there is provided a method for facilitating dispensation of medication comprising the steps of:
receiving multiple medication prescriptions, each prescription including at least one prescription item,
each medication prescription being associated with a specific dispenser,
locating a position of each at least one prescription item defined in each prescription of the multiple prescriptions, and;
providing a visual indication to each dispenser indicating a physical location of each of the at least one prescription item defined in each prescription, wherein a specific visual indication corresponding to each dispenser is provided such that multiple dispensers can simultaneously locate at least one prescription item from their associated prescription based on the specific visual indication corresponding to the dispenser.

The visual indication may be provided by one or more indicators on an indicator module. The indicator module may be in accordance with any of the earlier statements or according to a first aspect.

In one example, a unique colour may be associated with a specific dispenser. The specific visual indication may comprise presenting a unique colour corresponding to the specific dispenser to allow multiple dispensers to simultaneously identify and access one or more items defined in the prescription.

In one example the method comprises the additional steps of:
locating a physical location of each item in each of the multiple prescriptions, wherein each physical location corresponds to a specific compartment within the medicine cabinet,
transmitting activation signals to each indicator module associated with each compartment that retains an item defined in the prescription, and;
activating specific indicators associated with each specific dispenser to provide a visual indication to each specific dispenser the physical location of each item in the prescription associated with the specific dispenser.

Each prescription item defined in the medication prescription may include a herb or herbal compound or herbal formulation. The medication prescription may be a Traditional Chinese Medication formulation.

The term “herbs” or “herbal” refers to Traditional Chinese medicinal (TCM) compounds, or any materials or substances suitable for use in TCM practice or medicinal compounds, or any materials or substances suitable for use in any therapeutic or dietary treatments or programs. Such therapeutic or dietary treatments or programs are not limited to TCM practice but may include other types of traditional, alternative or modern medicinal practice, health, or well-being, dietary or psychology or psychiatry programs or treatments, as well as treatments for humans or veterinary treatment for animals. The compounds, materials or substances may also be in an unprocessed form (e.g., picked plant or fungi materials, cut from animals etc.), semi-processed form (lightly processed materials that been cut, dried, or preserved etc.), in a processed form (medicinal compounds processed in powder form, pellet form, tablet form, or mixed with other compounds or materials etc.), or any combination of the above.

The terms “herb” or “herbal” or “herbal formulation” may also cover a single herb or a mixture of multiple herbs. The term “herb” or “herbal” or “herbal formulation” can include one or more of plant elements as well as non-botanic substances such as animal products, fungi, mineral products, or other non-plant (i.e., non-botanic) products or element or any combination thereof, that may be used in the preparation of TCM formulations. These herbs may be processed in any suitable manner e.g., grinding, cutting, shredding, powdering etc. A TCM formulation may comprise one or more herbs. Herbs may define the constituent ingredients for TCM formulations or other medicinal formulations.

The term “comprising” (and its grammatical variations) as used herein are used in the inclusive sense of “having” or “including” and not in the sense of “consisting only of”.

It is to be understood that, if any prior art information is referred to herein, such reference does not constitute an admission that the information forms a part of the common general knowledge in the art, in any country.

### BRIEF DESCRIPTION OF THE DRAWINGS

Embodiments of the present invention will now be described, by way of example, with reference to the accompanying drawings in which:

FIG. 1 illustrates a block diagram of a medicine dispensing system in accordance with an embodiment of the present invention.

FIG. 2 illustrates a schematic diagram illustrating operative connections of the cabinet control module and other components of the medicine dispensing system.

FIG. 3 illustrates an example of a cabinet of the medicine dispensing system.

FIG. 4 illustrates an example compartment of the cabinet of FIG. 3.

FIG. 5 illustrates an example indicator module that is associated with a compartment of the cabinet.

FIG. 6 illustrates an underside of the indicator module of FIG. 5.

FIG. 7 illustrates a schematic diagram of the indicator module controller and its operative connections to other components of the indicator module.

FIG. 8 illustrates an example method for facilitating dispensation of a medicine using the system of FIG. 1.

### DETAILED DESCRIPTION OF THE PREFERRED EMBODIMENTS

TCM prescription is dispensed in various forms such as herbal decoctions, powders, pills, capsules and tinctures. The TCM formulation is formed from a combination of herbs, other plant material or non-botanic materials such as fungi or animal parts.

A qualified TCM practitioner is required to devise a prescription and identify the items defined in the prescription to prepare the prescribed medication e.g., prescribed TCM formulation. With a shortage of experienced TCM dispensing staff, and new, inexperienced staff joining there is a need for a system to guide inexperienced staff to the appropriate herbs i.e., items defined a prescription. Inexperienced staff can easily make mistakes when filling the prescription as they can often either not locate or locate an incorrect herb or ingredient. TCM dispensaries can also operate slowly due to the challenge in locating herbs defined in a prescription. In TCM dispensaries, the herbs i.e., ingredients of a TCM formulation are stored in a large cabinet that includes multiple compartments or drawers. It can be time consuming to for a TCM practitioner to locate the correct herbs defined in a TCM prescription. Examples of smart cabinets such as those described in U.S. Ser. No. 18/184,154 include digital implementations within the TCM environment to monitor the inventory stored in the medicine cabinets and to provide assistance to TCM dispensaries.

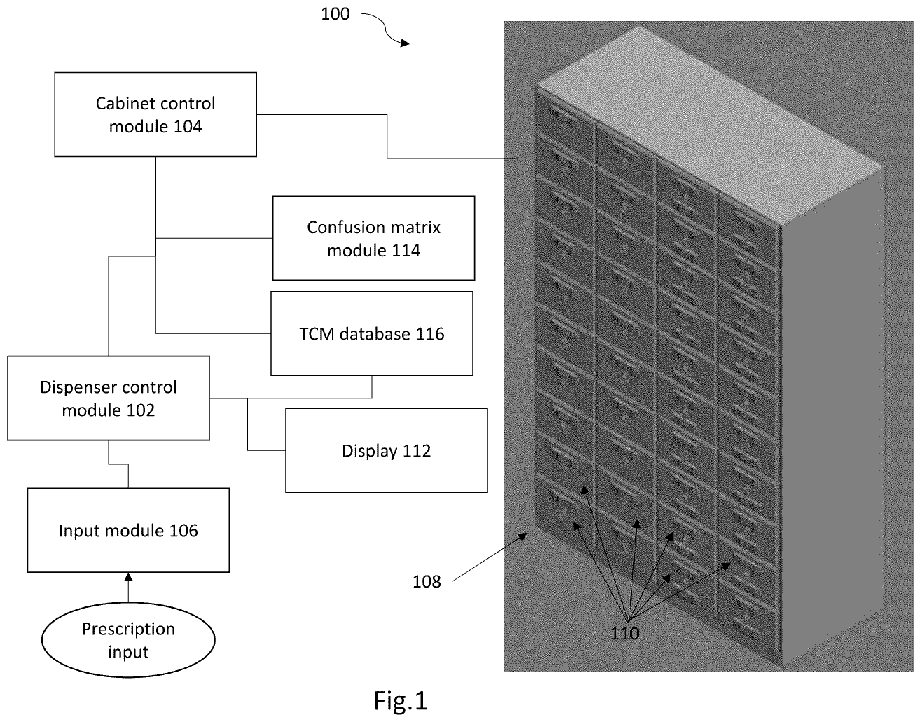

With reference to FIG. 1, there is shown an embodiment of a medicine dispensing system 100 comprising: a medicine cabinet 108; the medicine cabinet comprising a plurality of compartments 110, wherein each compartment is arranged to retain a medication prescription item, each compartment defining a physical location of a prescription item; a plurality of indicator modules 200, wherein each indicator module is associated with a single compartment 110; each indicator module comprising: a plurality of indicators 210; each indicator 210 comprising a unique colour and each indicator corresponding to an individual dispenser; the indicators 210 being activated to provide visual indication to a dispenser of the physical location of an item defined in a medication prescription; a dispenser control module 102 configured to receive a medication prescription including at least one prescription item; a cabinet control module 104 is configured to locate a physical location of each of the at least one prescription item stored in one of a plurality of predetermined compartment of the medicine cabinet; wherein the indicators 210 of an indicator module 200 are activated based on the prescription to indicate the physical location of each item defined in the prescription, and; wherein the indicators 210 are activated to allow a plurality of dispensers to simultaneously locate items defined within the prescription.

In this example embodiment, the medicine dispensing system 100 allows multiple dispensers e.g., multiple TCM dispensers to simultaneously dispense multiple prescriptions. The indicators including multiple colours and the indicators are activated to guide each TCM practitioner to the physical locations of the items in their individual prescription. The medicine dispensing system 100 of this example embodiment is advantageous as it can allow for more prescriptions to be filled as multiple dispensers (or multiple staff) can simultaneously work on prescriptions. Optionally, the medicine dispensing system 100 may also allow multiple dispensers to work together to fill a single prescription. The indicators 210 of the system may be operated to guide each dispenser i.e., staff member to the physical compartment that retains the item in the prescription. In this example, the items of the prescription may be divided into groups, and each group of items may be associated with a dispenser. The indicators 210 may be operated to guide each dispenser to the specific locations of their items. The dispensers may combine the gathered items to fill the prescription.

The medicine dispensing system 100 may be programmed to accurately locate the correct item e.g., herb or other item defined in a prescription stored in the medicine cabinet 108, which may comprise a plurality of compartments 110 such as for example drawers. Advantageously the medicine dispensing system 100 acts as a pick-to-light system where the physical locations of the specific herbs or ingredients for a prescription are lit up by the indicators. This pick-to-light system can help to reduce errors in medication dispensing e.g., reduce errors in identifying incorrect items of a TCM prescription. The system includes multiple indicators which advantageously allow multiple dispensers i.e., staff to work together and access items from the drawers 110 of the cabinet 108 and fill multiple prescriptions. Alternatively, the system allows a single prescription to be filled faster as the dispensers are simultaneously guided to the locations of the various ingredients of a prescription.

The medicine dispensing system 100 further comprises an input module 106. The input module 106, in use, is adapted to receive a prescription input. The input module 106 may be receive an input from a tablet or a phone or a workstation via a wireless message. Alternatively, the input module 106 may comprise a user interface e.g., buttons or a dial or a keyboard etc. The input module 106 may directly receive an input prescription via the user interface. The prescription input may define a plurality of items e.g., a plurality of ingredients. The ingredients may be herbs or other items that can be used for formulating the prescribed TCM formulation.

The dispenser control module 102 is adapted to receive the prescription input from the input module 106. The dispenser control module 102 may be adapted to coordinate all the different modules of the medicine dispensing system 100 in response to different inputs or predetermined events, so as to control the different modules to provide suitable output to assist in a medicine dispensing process. The dispenser control module 102 may be adapted to receive multiple prescriptions at once. The module 102 may be adapted to queue the prescriptions based on or more predetermined events. For example, the prescriptions may be queued based on urgency or based on complexity or based on availability of ingredients in the cabinet. The dispenser control module 102 may further be configured to store the available ingredients and the list of available ingredients may be updated as prescriptions are filled. The system 100 may comprise a TCM database 116. The TCM database 116 may be adapted to store a list of the available TCM herbs, their locations, and quantities. The quantities of each TCM herb (or ingredient) may be updated after each prescription is filled.

The medicine dispensing system 100 may optionally comprise a display module 112 arranged to notify a dispenser an error or a potential error associated with at least prescription item of the medication prescription.

The functional units and modules of the medicine dispensing system 100 in accordance with the embodiments disclosed herein e.g., the dispenser control module 102, the cabinet control module 104 and other components may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present invention. Computer instructions or software codes running in the computing devices, computer processors, or programmable logic devices can readily be prepared by practitioners skilled in the software or electronic art based on the teachings of the present invention.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, and magneto-optical disks, ROMs, RAMs, flash memory devices, or any type of media or devices suitable for storing instructions, codes, and/or data.

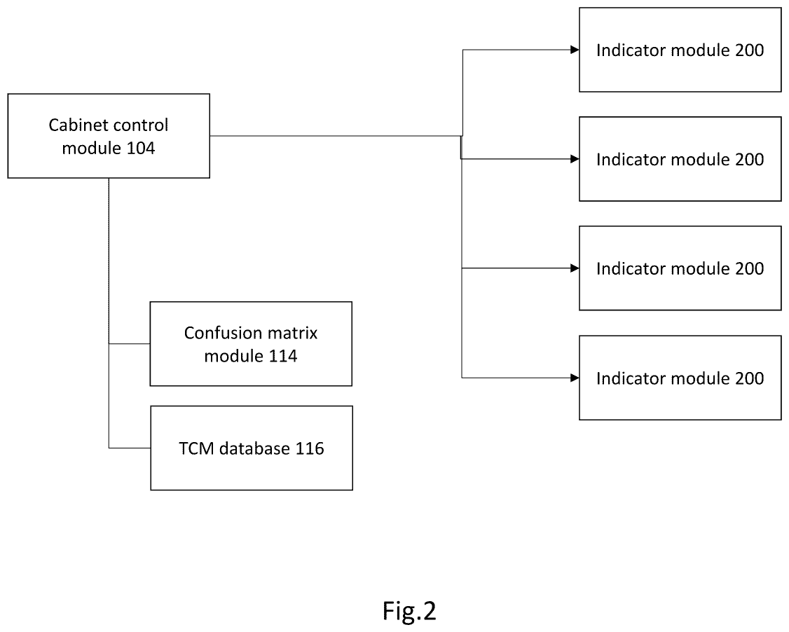

Referring to FIG. 2, the cabinet control module 104 is operatively coupled to the dispenser control module 102 and can receive data and transmit data to the dispenser control module 102. The cabinet control module 104 is operatively coupled to each indicator module 200 of the plurality of indicator modules and adapted to communicate with each indicator module 200. At least one indicator module is associated drawer 110 of the cabinet 108.

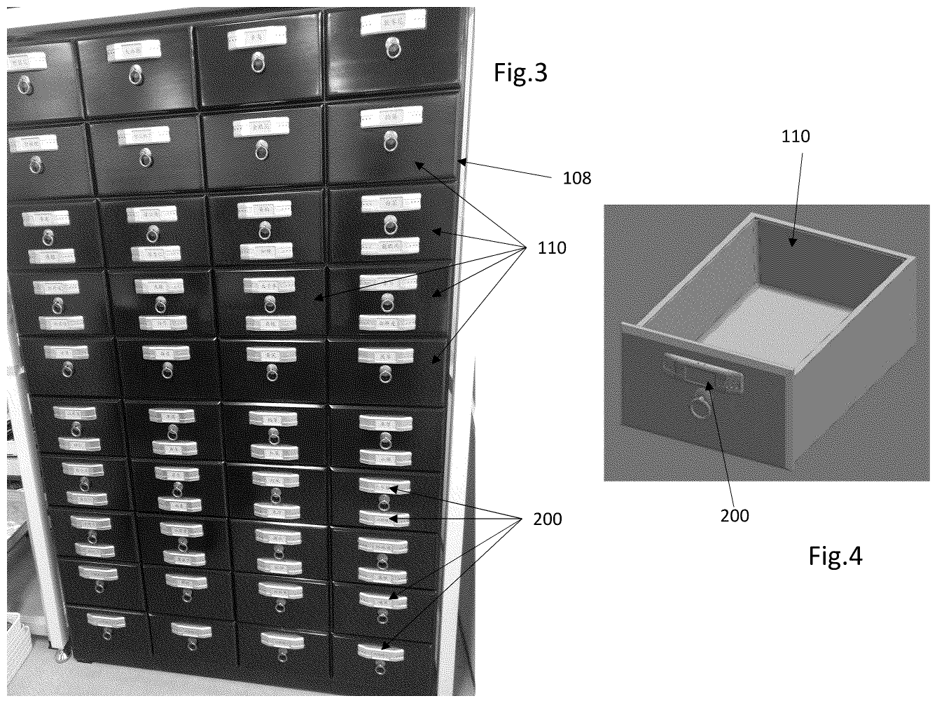

Referring to FIG. 3, the cabinet 108 may be a TCM cabinet (also known as a baizigui), which is a type of TCM cabinet. As shown in FIG. 3, the cabinet includes multiple drawers 110 for storing herbs or other medical ingredients. The cabinet 108 may be used by TCM practitioners e.g., TCM pharmacists or TCM doctors to store and organise supplies. FIG. 4 illustrates an example of a drawer 110. The drawer 110 defines an internal space to hold and retain herbs or other medicinal ingredients. Each drawer 110 includes at least one indicator module 200 disposed thereon. As shown in FIG. 4, an indicator module 200 is positioned above a handle of the drawer 110. As shown in FIG. 3, some drawers may include one indicator module 200 and some drawers include a plurality of indicator modules disposed thereon.

With continued reference to FIG. 2, the cabinet control module 104 is adapted to determine the position of each ingredient in the prescription. The position is defined as the specific compartment 110 within the cabinet 108 that includes the ingredient.

The cabinet control module 104 is adapted to access the location of a herb by referring to the TCM database 116. The TCM database 116 may be stored in a memory unit or in a cloud. In one example form, the TCM database 116 may be stored within the cabinet control module 104 and may be accessible by the cabinet control module 104. The TCM database 116 may be relational database that stores the relationship between herb and location in the cabinet e.g., drawer number.

Optionally or additionally, the medicine dispensing system 100 may comprise a confusion matrix 114 as shown in FIG. 1 and FIG. 2. The confusion matrix 114 may help to avoid dispensing staff picking TCM ingredients or TCM herbs that are similar to each other at the same time. This reduces dispensing errors. The confusion matrix 114 may be arranged schedule an activation sequence to activate the indicators in a staggered manner for two or more prescription items that are similar in appearance, defined in a single prescription.

The cabinet control module 104 is configured to utilise the information from the confusion matrix 114 to correct dispense prescription items and avoid dispensing errors. The confusion matrix 114 may be a table defining which specific TCM herbs or elements are similar. For example, say the prescription defines sweet almonds or in Chinese “Fj” (pick 30g) and bitter almonds, or in Chinese “IL” (pick 10g), the confusion matrix will avoid lighting up indicators on two indicator modules of the two drawers 110 simultaneously as sweet almonds and bitter almonds are similar in appearance, but are different ingredients. The cabinet control module 104 is configured to activate the indicators in a staggered manner e.g., in a sequential order to avoid the incorrect ingredients from being accessed.

Referring to FIG. 2, the cabinet control module 104 is configured to utilise the confusion matrix 114 and the TCM database 116 and provide an activation signal to one or more indicator modules 200. The cabinet control module 104 is configured to identify a specific compartment that retains the at least one prescription item, and; the cabinet control module is configured to transmit a signal to the indicator module 200 associated with the drawer to activate one or more indicators on the indicator module to visually indicate to a dispenser the physical location of the prescription item.

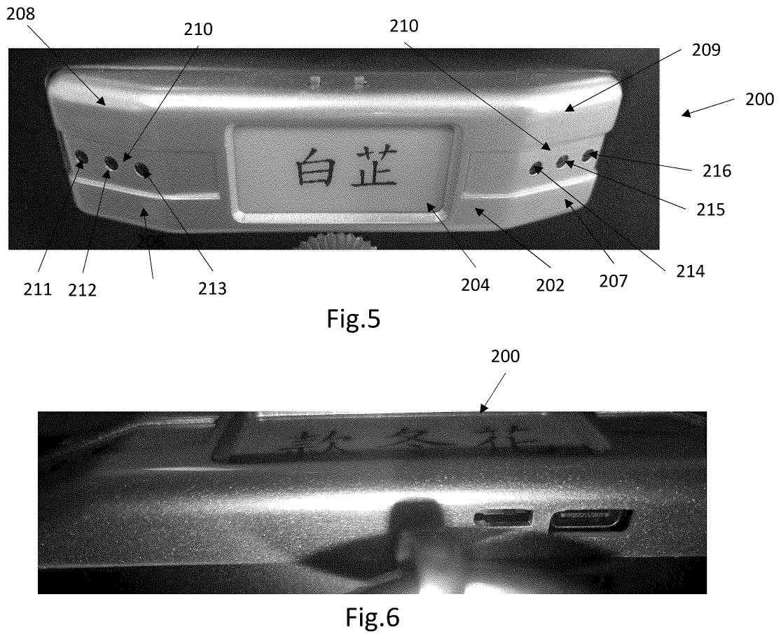

Referring to FIG. 5, there is shown an example embodiment of an indicator module 200. The indicator module 200 comprises a body. The indicator module further comprises a plurality of indicators 210 disposed on or within the body 202. Each indicator comprising a unique colour and each indicator corresponding to an individual dispenser. In one example the indicators 210 may be activated to provide visual indication to a dispenser of the physical location of an item defined in a medication prescription, wherein the indicators being activated to allow a plurality of dispensers to simultaneously locate items within the cabinet.

As shown in the example embodiment of FIG. 5, the indicator module 200 comprises a central portion 204 and at least one lateral extension 206 extending outwardly from the central portion 204. The lateral extension comprising a bevelled region 208. The plurality of indicators 210 being positioned on the bevelled region 208. As shown in FIG. 5, the body 202 comprises two lateral extensions 206, 207 extending outwardly from the central portion 204. The lateral extensions 206, 207 extending in opposing directions from the central portion 204. Each lateral portion comprises a bevelled region 208, 209.

The indicators 210 are divided into a first group of indicators 211, 212, 213 and a second group of indicators 214, 215 and 216. A first group of indicators 211-213 are disposed on a bevelled region 208 of a first lateral extension 206. A second group of indicators 214-216 disposed on a bevelled region 209 of the second lateral extension 207. The two groups of indicators may be identical to each other.

Each group of indicators comprises three indicators as shown in FIG. 5. The indicators 211-213 or 214-216 are arranged horizontally or may be arranged vertically or in any suitable configuration. One indicator comprises a first colour, one indicator comprises a second colour and one indicator comprises a third colour. Each colour corresponding to a separate dispenser to allow at least three dispensers to simultaneously locate items within the cabinet based on the specific coloured indicator being activated. The indicators are arranged on the bevelled sections. The two sets of indicators are advantageous as it provides improved visibility. The indicators are visible from both directions due to their position on the bevelled section. This improves perceptibility of the indicators by the dispensers.

In the illustrated embodiment of FIG. 5 the indicators in the first group and second group define pairs such that the same indicator in the first and second groups are activated together. The pairs of indicators may be simultaneously activated in use,

to allow three dispensers to simultaneously locate items within the cabinet 108, and more specifically the compartment 110 that is associated with the lit indicators. In one example, each group comprises a red indicator, a green indicator, and a blue indicator. Each indicator may be an LED or other suitable light source e.g., CFL bulbs. In one example, the indicators are RGB LEDs.

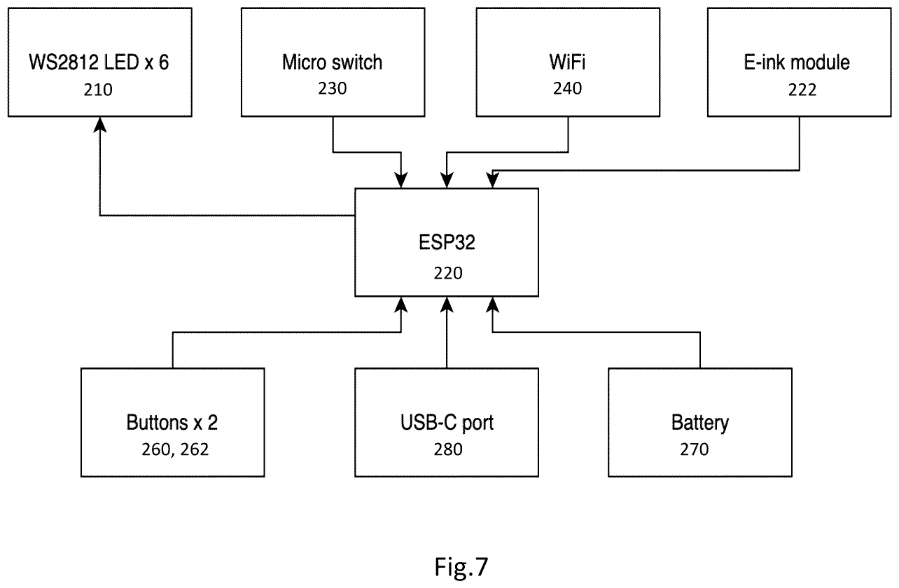

Referring to FIG. 7, a schematic diagram of an indicator module 200 is illustrated. The indicator module 200 may comprise an indicator module controller 220. The indicator module controller is operatively coupled to each of the indicators 211-216. The indicator module controller 220 may be an ESP32 module. The indicator module controller 220 may be another suitable microcontroller or microprocessor or an application specific integrated circuit (ASIC) or a field programmable gate array (FPGA) or other programmable logic device configured or programmed according to the teachings of the present invention. The indicator module controller 220 comprises at least a processor and a memory unit. The processor is configured to perform various operations as described herein, and the memory unit may store data and executable instructions. Computer instructions or software codes running in the computing devices, computer processors, or programmable logic devices can readily be prepared by practitioners skilled in the software or electronic art based on the teachings of the present invention.

The indicator module 200 further comprises an adjustable label 222 i.e., an e-ink module, micro switch 230, a Wi-Fi module 240, a dynamically adjustable label 250, two buttons 260, 262 (for example a disable button 260 and a reboot button 262), a battery 270 and a USB port 280. The indicator module controller 220 is operatively coupled to the above components. The battery 270 is operatively coupled to the indicators to power the indicators. The disable button 260 may be disposed on the body and is configured to disable the indicator module or cause the indicator module to enter a sleep mode when the button is actuated. The reboot button 262 may be disposed on the body and is configured to cause the indicator module to reboot when it is activated.

The adjustable label 222 may be positioned on the central portion 204 of the body 202. The label 222 is dynamically adjustable. In one example, the dynamically adjustable label 222 comprises an e-ink module that can display the name or an image of the contents of the compartment associated with the indicator module 200. Each compartment 110 includes an adjustable label positioned on its associated indicator module 200. The indicator module controller 220 is operatively coupled to the e-ink module 222 and the controller 220 is further configured to control a visual appearance of the label 222 (i.e., the e-ink module). The controller 220 may change the appearance of the e-ink module 222 (i.e., adjustable label) based on the received wireless messages. For example, if the contents of the compartment 110 are changed or if the compartment is empty or if the compartment contents have not been weighed etc.

The USB port 280 may be positioned on an underside of the body, as shown in FIG. 6 to allow one or more other accessories to connect to the indicator module 200 e.g., to upload or download data from the indicator module 200. The USB port may be a USB-C port or other suitable port. As shown in FIG. 6, the disable button 260 and the reboot button 262 may be disposed on an upper surface or on a topside of the body 202.

In one example, the indicator module controller 220 may be configured to disable the indicators 211-216 when the disable button 260 is actuated. The controller 220 may be configured to reboot the indicator module 200 when the reboot button 262 is actuated. The controller 200 may be further configured to reset settings e.g., indicator colours when reboot button is actuated. The controller 220 may be configured to receive inputs from the USB port. The controller 220 may further be configured to track battery power and provide an indication of the battery being low in power.

The indicator module 200 may also include a charging module (not shown) that is adapted to charge the battery. The charging module inlet 290 may be positioned adjacent the USB port, on an underside of the module 200 as shown in FIG. 6.

The Wi-Fi module 240 may be a wireless communication module that is configured to allow two way communication with the cabinet control module 104. The indicator module controller 220 can receive commands via the Wi-Fi module 240. The Wi-Fi module 240 may allow communication via the Wi-Fi protocol, but may alternatively be any other suitable communication module to allow wireless communication between each indicator module 200 and the cabinet control module 104 e.g., Bluetooth, ZigBee etc.

The indicator module controller 220 operatively connect to one or more micro switches 230 of a compartment associated with the indicator module 220. The indicator module controller 220 is configured to determine the position of the compartment based on the position of the micro switch 230. The controller 220 is configured to adjust visual appearance of the label 222 if the compartment is determined to be opened for longer than a threshold time based on the determined position of the compartment. For example, the e-ink module 222 (i.e., adjustable label) may be lit up to indicate the compartment has been open too long.

The indicator module controller 220 is configured to independently activate the indicators to allow multiple dispensers i.e., multiple staff to simultaneously locate items within one or more compartments 110 of the cabinet 108. The indicator module controller 220 is configured to activate a plurality of indicators of different colours to indicate to the dispensers associated with the indicators the location of an item defined in a prescription such that the dispensers can simultaneously be guided to the location of the item defined in the prescription.

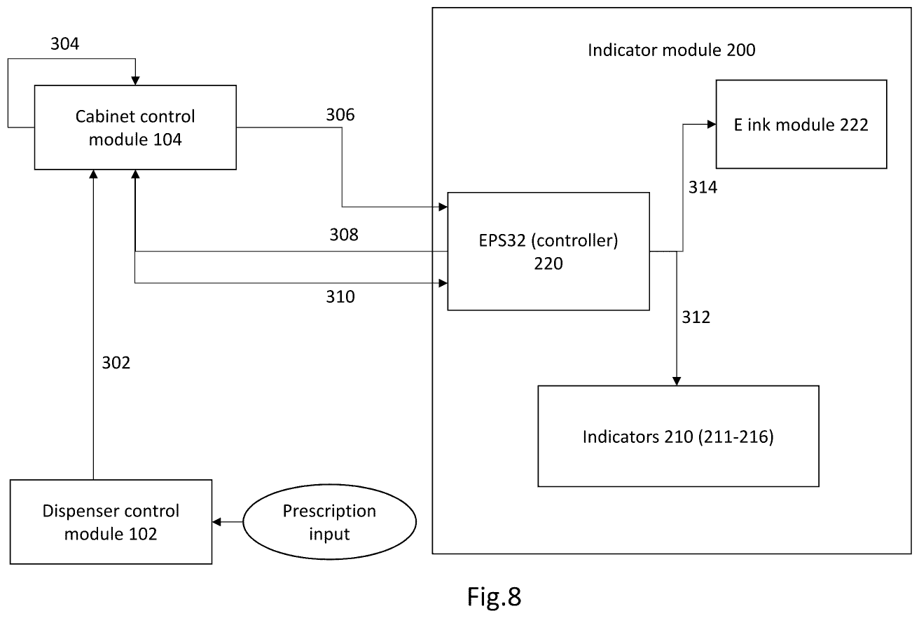

Referring to FIG. 8, an example operation of the system 100 will be described. FIG. 8 illustrates an example method for facilitating dispensation of a medicine. The dispenser control module 120 is configured to receive a prescription input from the input module 106. The prescription input may be a single prescription or multiple prescriptions. The system 100 is configured for multiple prescriptions to be received, wherein each prescription is associated with a specific dispenser.

The prescription items i.e., constituents or ingredients such as for example herbs, may be extracted within the dispenser control module and transmit the items to the cabinet control module 104 at step 302. The cabinet control module 104 is configured to determine physical location of each item at step 304. Step 304 comprises locating a position of each at least one prescription item defined in each prescription of the multiple prescriptions.

Step 306 comprises pinging the indicator module 200 associated with the specific compartment that has the item within it. The ping message is transmitted at step 306 to the controller 220. A response message 308 is transmitted from the controller 220 to the cabinet control module 104. A MQTT connection may be established over Wi-Fi between the indicator module 200, in particular the indicator module controller 220 and the cabinet control module 104. At step 310 the cabinet control module 104 is configured to transmit activation signals to each indicator module associated with each compartment that retains an item defined in the prescription. FIG. 8 illustrates one indicator module 200 for illustrative purposes. The activation signal may be transmitted as a subscribe/publish MQTT message from the module 104. The module 104 may function as an MQTT broker or may comprise an MQTT broker.

At step 312 the indicator module on the compartment that retains a prescription item is configured to activate specific indicators associated with each specific dispenser to provide a visual indication to each specific dispenser the physical location of each item in the prescription associated with the specific dispenser. This allows multiple dispensers to simultaneously use the system 100 and access items from the cabinet 108. For example, the indicator modules may activate green indicators (lights) to indicate the physical locations for a first dispenser's items, activate blue indicators (lights) to indicate the physical locations of a second dispenser's items and red indicators (lights) to indicate the physical locations of a third dispenser's items. In some indicator modules 200, the controller 220 may activate all three indicators (lights). This allows a plurality e.g., three dispensers to simultaneously fill a prescription and gather items defined in each other their prescriptions.

Step 314 may include the indicator module controller 220 to update or change the appearance of the e-ink module 222. The e-ink module may be changed if the compartment is detected as being open for too long or if the contents of the compartment are empty or one or more other conditions have been satisfied. The confusion matrix module 114 may be arranged schedule an activation sequence to activate the indicators in a staggered manner for two or more prescription items that are similar in appearance, defined in a single prescription. The activation controls the activation of the indicators in a staggered manner for two or more similar prescription items that are present in two or more prescriptions to avoid two dispensers accessing similar prescription items defined in their respective prescriptions.

The error may include a wrong prescription item being selected due to confusion. The error may relate to an incorrect dispenser accessing a prescription item due an error in the indicator light colour. Other errors are contemplated. The cabinet control module or dispenser control module may be configured to detect one or more errors and present the error on the display module.

In one example implementation, the system 100 is adapted to allow three users to simultaneously fill a single prescription by activating the specific indicator colour corresponding to a specific dispenser to guide the dispenser to a location of a prescription item. The dispenser control module 102 may be configured to associate one or more items from the prescription to a dispenser such that no dispenser has to access the same item. The cabinet control module 104 may be configured to receive the list of items and the item association to the dispenser i.e., the relationship between each item and associated dispenser. The cabinet control module 104 is further configured to transmit signals to one or more indicator modules 200 to activate the indicator of the colours associated with the dispensers to guide the dispensers to the physical locations of the items associated with each dispenser, such that the dispensers can simultaneously gather their respective items to fill the prescription.

In a further example implementation, the system 100 is adapted to allow multiple dispensers to simultaneously fill multiple prescriptions, wherein each dispenser is associated with a single prescription. The dispenser control module 102 may be configured to transmit a plurality of prescriptions to the cabinet control module 104, wherein each prescription is associated with an individual dispenser i.e., each dispenser is responsible for a single prescription. The cabinet control module 104 may be configured to identify the physical locations of each item in each prescription. The cabinet control module may be further configured to transmit signals to one or more indicator modules 200 to activate the indicators of the colours associated with each dispenser to guide each dispenser to the physical locations of the items within their respective prescription. The specific coloured indicators being activated allows multiple dispensers to simultaneously fill multiple prescriptions.

In each of the example implementations the indicator module controller 220 of each indicator module is configured to control the activation of the indicators based on the received instruction i.e., received signals from the cabinet control module 104.

The system is advantageous as it allows multiple dispensers (i.e., multiple) users to simultaneously fill prescriptions by picking one or more prescription items defined in the prescription. The system provides a specific visual indication corresponding to each dispenser is provided such that multiple dispensers can simultaneously locate at least one prescription item from their associated prescription based on the specific visual indication corresponding to the dispenser. The controller 220 is configured to activate the indicators associated with a particular dispenser to guide the dispenser to the items in their prescription. The indicators provide a colour coded guidance mechanism which avoids confusion when multiple dispensers are operating together. The system 100 is advantageous as it allows multiple dispensers to work together improving speed and efficiency of filling prescriptions in a TCM pharmacy or dispensary.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components, and data files assisting in the performance of particular functions, the skilled person will understand that the functionality of the software application may be distributed across a number of routines, objects, or components to achieve the same functionality desired herein.

It will also be appreciated that where the methods and systems of the present invention are either wholly implemented by computing system or partly implemented by computing systems then any appropriate computing system architecture may be utilized. This will include tablet computers, wearable devices, smart phones, Internet of Things (IoT) devices, edge computing devices, stand alone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An indicator module for a medicine dispensing system, the indicator module adapted for use with a medicine cabinet comprising:
a body,
a plurality of indicators disposed on or within the body,
each indicator comprising a unique colour and each indicator corresponding to an individual dispenser,
the indicators being activated to provide visual indication to a dispenser of the physical location of an item defined in a medication prescription, wherein the indicators being activated to allow a plurality of dispensers to simultaneously locate items within the cabinet.

2. The indicator module for a medicine dispensing system of claim 1, in use, the indicators being independently activated to allow multiple dispensers to simultaneously locate items within one or more compartments of the cabinet.

3. The indicator module for a medicine dispensing system of claim 2, wherein the indicator module comprises at least three indicators,
wherein one indicator comprises a first colour, one indicator comprises a second colour and one indicator comprises a third colour, and;
each colour corresponding to a separate dispenser to allow at least three dispensers to simultaneously locate items within the cabinet based on the specific coloured indicator being activated.

4. The indicator module for a medicine dispensing system of claim 2, wherein the body comprises:
a central portion
at least one lateral extension extending outwardly from the central portion, wherein the lateral extension comprising a bevelled region, and;
the plurality of indicators being positioned on the bevelled region.

5. The indicator module for a medicine dispensing system of claim 4, comprising at least two groups of indicators,
each group of indicators comprising a plurality of indicators, the indicators in each group being identical to each other,
wherein the body comprises two lateral extensions extending outwardly from the central portion, the lateral extensions extending in opposing directions from the central portion,
each lateral portion comprising a bevelled region, a first group of indicators disposed on a bevelled region of a first lateral extension and a second group of indicators disposed on a bevelled region of the second lateral extension, and;
the plurality of indicators being independently activated, in use, to allow multiple dispensers to simultaneously locate items within the cabinet.

6. The indicator module for a medicine dispensing system of claim 5, wherein the first group of indicators comprising three indicators and the second group of indicators comprising three indicators,
wherein the indicators in the first group and second group define pairs such that the same indicator in the first and second groups are activated together,
the three indicators in each group being a different colour,
the pairs of indicators being simultaneously activated in use, and;
wherein the indicators in the first group and the second group being activated, in use, to allow three dispensers to simultaneously locate items within the cabinet.

7. The indicator module for a medicine dispensing system of claim 6, comprising:
an indicator module controller associated with the indicator module,
the indicator module controller operatively coupled to each of the indicators, and;
wherein the indicator module controller is configured to wirelessly receive a message to activate one or more indicators to indicate to one or more dispensers a location of an item defined in a prescription within the compartment associated with the indicator module.

8. The indicator module for a medicine dispensing system of claim 7, wherein the indicator module controller is configured to activate a plurality of indicators of different colours to indicate to the dispensers associated with the indicators the location of an item defined in a prescription such that the dispensers can simultaneously be guided to the location of the item defined in the prescription.

9. The indicator module for a medicine dispensing system of claim 8, comprising: a dynamically adjustable label disposed on the central portion of the body, wherein the label displaying a label of the contents of a compartment of the cabinet,
wherein the indicator module controller is operatively coupled to the dynamically adjustable label, and;
the indicator module controller is configured to control a visual appearance of the label or change the contents of the label based on a received wireless message.

10. The indicator module for a medicine dispensing system of claim 9 wherein the indicator module controller is configured to:
operatively connect to one or more micro switches of a compartment associated with the indicator module, wherein the compartment is a compartment of the medicine cabinet,
determine the position of the compartment based on the position of the micro switch, and;
adjust visual appearance of the label if the compartment is determined to be opened for longer than a threshold time based on the determined position of the compartment.

11. The indicator module for a medicine dispensing system of claim 10, wherein the dynamically adjustable label is an e-ink module that can display a name or image indicative of the contents of the compartment associated with the indicator module.

12. The indicator module for a medicine dispensing system of claim 10, comprising:
a battery, the battery being operatively coupled to the indicators to power the indicators,
a disable button disposed on the body, wherein the disable button is configured to disable the indicator module or cause the indicator module to enter a sleep mode when the button is actuated,
a reboot button disposed on the body, wherein the reboot button is configured to cause the indicator module to reboot when the reboot button is activated, and;
a USB port on an underside of the body.

13. A medicine dispensing system comprising:
a medicine cabinet,
the medicine cabinet comprising a plurality of compartments,
wherein each compartment is arranged to retain a medication prescription item, each compartment defining a physical location of a prescription item,
a plurality of indicator modules, each indicator module is associated with a single compartment,
each indicator module comprising:
a body,
a plurality of indicators disposed on or within the body,
each indicator comprising a unique colour and each indicator corresponding to an individual dispenser,
the indicators being activated to provide visual indication to a dispenser of the physical location of an item defined in a medication prescription,
a dispenser control module configured to receive a medication prescription including at least one prescription item,
a cabinet control module configured to locate a physical location of each of the at least one prescription item stored in one of a plurality of predetermined compartment of the medicine cabinet,
wherein the indicators of an indicator module are activated based on the prescription to indicate the physical location of each item defined in the prescription, and;
wherein the indicators are activated to allow a plurality of dispensers to simultaneously locate items within the cabinet as defined within the prescription.

14. The medicine dispensing system of claim 13, wherein the cabinet control module is configured to identify a specific compartment that retains the at least one prescription item, and;
the cabinet control module is configured to transmit a signal to an indicator module to activate one or more indicators on the indicator module to visually indicate to a dispenser the physical location of the prescription item.

15. The medicine dispensing system of claim 14, wherein the dispenser control module is configured to receive multiple prescriptions, each prescription associated with a specific dispenser,
wherein the cabinet control module is configured to:
locate a physical location of each item in each of the multiple prescriptions, wherein each physical location corresponds to a specific compartment within the medicine cabinet,
transmit activation signals to each indicator module associated with each compartment that retains an item defined in the prescription, and;
the indicator module on each compartment that retains a prescription item is configured to activate specific indicators associated with each specific dispenser to provide a visual indication to each specific dispenser the physical location of each item in the prescription associated with the specific dispenser.

16. The medicine dispensing system of claim 15, comprising a confusion matrix module arranged schedule an activation sequence to activate the indicators in a staggered manner for two or more prescription items that are similar in appearance, defined in a single prescription.

17. The medicine dispensing system of claim 15, wherein the indicator module comprises at least three indicators,
wherein one indicator comprises a first colour, one indicator comprises a second colour and one indicator comprises a third colour,
each colour corresponding to a separate dispenser to allow at least three dispensers to simultaneously locate items within the cabinet based on the specific coloured indicator being activated, and;
the cabinet control module is configured to independently activate indicators of appropriate colours based on the prescription associated with a specific dispenser, wherein the specific colours of the indicator indicating to the specific dispenser the physical location of an item within the prescription associated with that dispenser.

18. The medicine dispensing system of claim 16, wherein the activation sequence is further configured to control the activation of the indicators in a staggered manner for two or more similar prescription items that are present in two or more prescriptions to avoid two dispensers accessing similar prescription items defined in their respective prescriptions.

19. The medicine dispensing system of claim 18, wherein each indicator module of the plurality of indicator modules is an indicator module adapted for use with a medicine cabinet comprising: a body, a plurality of indicators disposed on or within the body, each indicator comprising a unique colour and each indicator corresponding to an individual dispenser, the indicators being activated to provide visual indication to a dispenser of the physical location of an item defined in a medication prescription, wherein the indicators being activated to allow a plurality of dispensers to simultaneously locate items within the cabinet.

20. A method for facilitating dispensation of medication comprising the steps of:
receiving multiple medication prescriptions, each prescription including at least one prescription item,
each medication prescription being associated with a specific dispenser,
locating a position of each at least one prescription item defined in each prescription of the multiple prescriptions, and;
providing a visual indication to each dispenser indicating a physical location of each of the at least one prescription item defined in each prescription, wherein a specific visual indication corresponding to each dispenser is provided such that multiple dispensers can simultaneously locate at least one prescription item from their associated prescription based on the specific visual indication corresponding to the dispenser.
